(19) United States
(12) Patent Application Publication
(10) Pub. No.: US 2023/0245190 A1
(43) Pub. Date: Aug. 3, 2023

(54) END-TO-END ACTIVE MULTI-LEVEL SECURE PREDICTIVE REAL-TIME AUTOMATION SYSTEM

(71) Applicant: ChaseMe, LLC, Dover, DE (US)

(72) Inventors: Shahar Sean Aviv, Cooper City, FL (US); Shiri Batia Aviv, Boca Raton, FL (US)

(21) Appl. No.: 18/148,146

(22) Filed: Dec. 29, 2022

Related U.S. Application Data
(60) Provisional application No. 63/294,526, filed on Dec. 29, 2021.

(51) Int. Cl. G06Q 30/0601; G06F 16/9535; G06F 16/9536

(52) U.S. Cl. CPC G06Q 30/0611; G06F 16/9535; G06F 16/9536

(57) ABSTRACT

A system includes a computer. The computer includes a processor and a memory. The memory includes instructions such that the processor is programmed to: receive a buyer search query, the buyer search query including pricing details and non-pricing details, initiate a continuous search for a predefined time period based on the buyer search query, and execute an automated purchase based on the continuous search.

### BACKGROUND

The existing online eCommerce/online marketplace environment is extremely time consuming for buyers and sellers alike with no complete end-to-end eCommerce automation. There is no security automation, there is a lack of artificial intelligence, and no ability to automate the entire eCommerce process in a complete multiway fashion. There is currently no ability to conduct all aspects of the buying and selling lifecycle including automated active continuous eCommerce searches, automated multiway negotiations of pricing and non-pricing attributes, automated pricing and non-pricing purchasing recommendations, automated custom bookings, automated discounting, automated pre-purchase/post purchase price matching, automated predictive/future looking pricing and non-pricing recommendations, automated purchasing, automated intelligent active eCommerce search cloning for expedited multiple eCommerce searches, automated filtering for unique offers, results, and listings that are overlayed with a real-time multi-level secure eCommerce gateway for advanced real-time eCommerce threat protection, fraud prevention, and eCommerce security filters and user security customization capabilities. Existing systems do not have any user security controls.

With existing eCommerce systems, buyers and sellers continuously conduct manual searches through many online eCommerce platforms to find their products, services, travel needs, real estate, automobiles, etc. Current eCommerce systems, online buying and selling processes, and buyer/seller experiences, are very time consuming, require repetitive searches, provide duplicate results and listings, require manual negotiations, are inefficient, lack relevancy, lack content/filtering control, have no real-time security analysis and threat mitigation, have no automated price-match and automated discounting mechanisms, and are limited in both buyer and seller sales outcome optimization.

Current eCommerce platforms lack user centric automation and require buyers, sellers, and the integrated eCommerce platform ecosystems to take continuous action throughout the eCommerce search and sales cycle. Current platforms also lack predictive automated future looking mechanisms, automated pricing and non-pricing analysis, and automated actions to deliver an optimal buyer, seller, and eCommerce platform experience and outcome. Moreover, current platforms lack real-time eCommerce threat intelligence-based security enforcement and eCommerce security content filtering capabilities.

These shortcomings are especially relevant with the recent increase in the utilization of online eCommerce platforms due to COVID-19. As a result, the market requires a shift into a complete end-to-end automated online sales solution from eCommerce search to acquisition in highly intelligent and persistent security enforcement methods and systems.

### SUMMARY

The present disclosure is directed to an autonomous ecommerce system that satisfies the above-mentioned eCommerce and online marketplace gaps and needs and provides tremendous enhancements and improvements to the online eCommerce industry. The system and method for a complete artificial intelligence (AI) driven active and automated eCommerce platform enables end-to-end streamlining and automation of the sales cycle from search to acquisition across a complete ecosystem of online eCommerce systems. Utilizing AI algorithms and active continuous eCommerce search methods, the intelligence and automation are optimized for any user and systems including of buyers, sellers, service providers, merchants, agents, eCommerce platforms, booking systems, retailers, API based systems, etc.

The system and method comprising the active continuous search, the automated negotiations, automated purchasing, automated price matching, integration into 3^{rd} party systems such as automation bookings via 3^{rd} party systems, overlayed with real-time threat and fraud protection solve for the current time-consuming buyer and seller online sales experience, the lack of security controls, and lack of price optimization.

As shown in FIG. 12, the disclosed disclosure provides a fully automated and secure eCommerce experience that searches for product, services, bookings, etc. and performs all other aspect of the transaction. This is a revolutionary active eCommerce platform that is real-time secure with complete end to end automation and is a highly optimized and fine-tuned system aimed to deliver the best eCommerce outcomes for sellers and buyers.

### BRIEF DESCRIPTION OF THE DRAWINGS

A more complete understanding of the present disclosure, and the attendant advantages and features thereof, will be more readily understood by reference to the following description when considered in conjunction with the accompanying drawings wherein:

FIG. 1 is a system schematic diagram illustrating an implementation of an end-to-end multi-level active, automated, intelligent, predictive, and secure eCommerce platform according to the disclosure.

FIG. 2 is a flowchart illustrating an implementation of the multiway automated active continuous eCommerce search, multi-search, and active synchronization module according to the disclosure.

FIG. 3 is a flowchart illustrating an implementation of the automated intelligent cloning & automated intelligent search text analysis for conversion and creation of search criteria algorithm according to the disclosure.

FIG. 4 is a flowchart illustrating an implementation of the automated multiway active-synchronization-based match and save of unique results & offers algorithm according to the disclosure.

FIG. 5 is a flowchart illustrating an implementation of the automated preemptive multiway cross-platform listing analysis, isolation of duplicate listings, and activation of unique listings algorithm according to the disclosure.

FIG. 6 is a flowchart illustrating an implementation of the multiway automated predictive pricing and non-pricing recommendations and seller price matching algorithm according to the disclosure.

FIG. 7 is a flowchart illustrating an implementation of the automated multiway negotiation of pricing and non-pricing criteria algorithm according to the disclosure.

FIG. 8 is a flowchart illustrating an implementation of the automated proactive seller offers algorithm according to the disclosure.

FIG. 9 is a flowchart illustrating an implementation of the predictive automated intelligent purchase and automated discounting algorithm according to the disclosure.

FIG. 10 is a flowchart illustrating an implementation of the multiway automated pre-purchase and post-purchase price matching & automated refunding algorithm according to the disclosure.

FIG. 11 is a flowchart illustrating an implementation of the automated intelligent secure eCommerce gateway for real-time eCommerce threat protection, fraud prevention, and eCommerce security filtering according to the disclosure.

FIG. 12 shows various aspects of the system and method according to the disclosure.

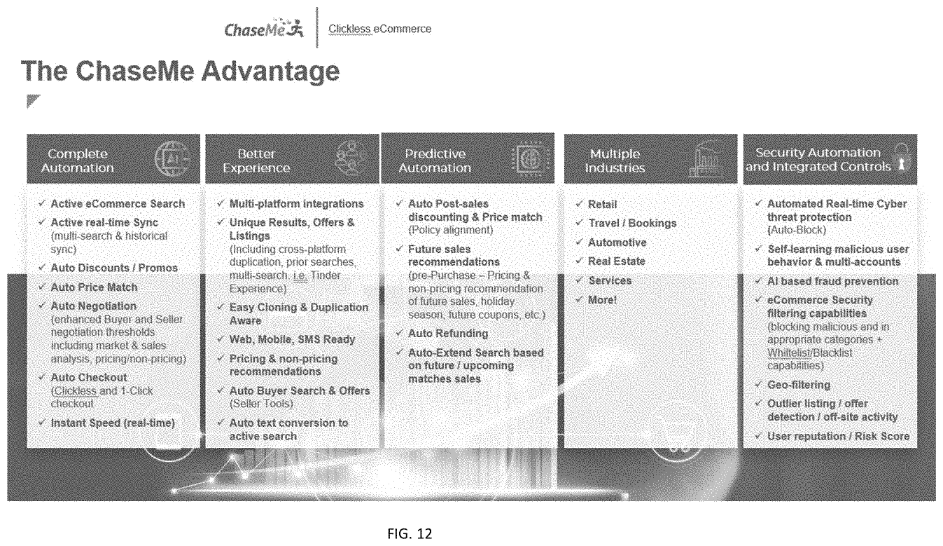

In general, boxes and other elements shown with dashed lines indicate steps that are automated, without any input or other action from the user.

### DETAILED DESCRIPTION

### Overview

In general, the disclosure relates to a system and method for a multi-level AI-driven automated, active, real-time secure, highly optimized, and a predictive future looking eCommerce platform. The system and method provide buyers, sellers, service providers, merchants, agents, eCommerce platforms, booking systems, retailers, API based systems, etc. with an end-to-end AI-driven automated, predictive, and secure eCommerce platform. The system utilizes a multiway continuous active eCommerce search, intelligent unique-match enforcement of results, offers, automated system-generated results/offers/listings that are optimized for cross-platform and booking platform automation, as well as user generated results/offers/listings that are optimized for buyers, sellers, and API integrated user applications.

Implementations of the present disclosure include advanced eCommerce capabilities including automated active continuous search and automated purchasing whereas the system is actively searching even while the users are offline and can follow through the automated purchases based on pre-set criteria. The automated multiway negotiations of pricing and non-pricing attributes are design to optimize the sales outcomes for buyers, sellers, and merchants alike. The system also automates pre-purchase and post-purchase discounts and price matching to best price automation even after the purchase transaction complete. To enhance the current user experience, the system optimizes relevancy with AI-driven algorithms to ensure unique results, offers, and listings so only relevant and non-duplicative eCommerce information is presented to the users. For advanced security, the system entails a real-time AI-driven threat and fraud prevention system to provide security controls, eCommerce content filtering, and automated transaction blocking based on risk profiles.

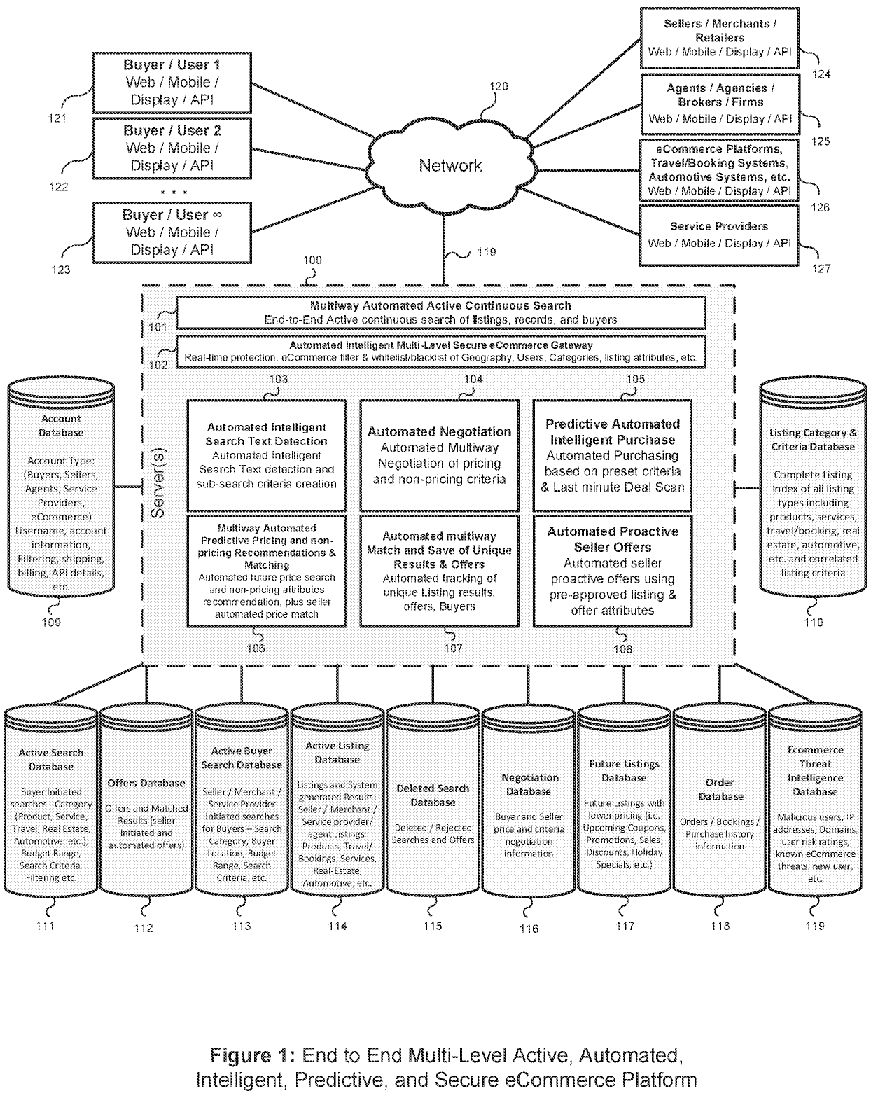

FIG. 1 illustrates a high-level system schematic diagram of an implementation of the end-to-end multi-level active, automated, intelligent, predictive, and secure eCommerce platform according to the disclosure. As illustrated in FIG. 1, the eCommerce platform application server(s) 100 are connected to a communications network 125 such as the internet via any suitable transport method 124. The eCommerce platform application server(s) allow an ecosystem of multiple users and external systems such as a number of buyers including buyer/user1 130, buyer/user2 131, . . . buyer/user(n) 132; one or more sellers, merchants, and retailers 126; one or more agents, agencies, brokers, and firms 127; one or more eCommerce systems, travel/booking systems, and automotive systems 128; one or more service providers 129, etc. to access the platform via web, mobile, display, API, websites, applications, or any other appropriate software and/or interface. The eCommerce platform application server(s) 100 are implemented as one or multiple applications and consist of multiple components, systems, algorithms, and databases that reside on one or multiple servers and accessible via the public internet or any other network 125.

For example, server(s) 100 can include or be otherwise connected to a variety of databases, including, but not limited to:

Account Database 109—which can include account types (buyers, sellers, agents, service providers, etc.), username, account information, filtering, settings, shipping, billing, API details, etc.

Listing Category & Criteria Database 110—which can include complete listing index of all listing types such as products, services, travel/booking, real estate, automotive, etc. and correlated listing criteria.

Active eCommerce Search Database 111—which can include buyer-initiated searches-category (product, service, travel, real estate, automotive, etc), budget range, search criteria, filtering etc.

Offers Database 112—which can include Offers and Matched Results (seller Results (seller initiated and automated offers).

Active Search for Buyers Database 113—which can include seller/merchant/service provider-initiated searches for buyers—search category, buyer requirement data, budget range, search criteria, etc.

Active Listing Database 114—which can include active listing ID, listing source, user listings and system generated listings: seller/merchant/service provider/agent listings: products, travel/bookings, services, real-estate, automotive, etc.

Non-Active Listing Database 115—which can include inactive listing ID, listing source, user listings and system generated listings: seller/merchant/service provider/agent listings: products, travel/bookings, services, real-estate, automotive, etc.

Expired & Historical Listings Database 116—which can include expired, archived, and duplicate listing IDs, including listing ID, listing source, user listings and system generated listings: seller/merchant/service

Deleted & Historical Search and Results Database 117—which can include deleted/rejected search results and offers.

Negotiation Database 118—which can include Negotiation data of pricing and non-pricing attributes, market data, buyer and seller proposition activity, etc.

Future Listings Database 119—which can include future listings with different pricing (i.e. upcoming coupons, promotions, sales, discounts, holiday specials, etc.).

Order Database 120—which can include orders/bookings/purchase history information, etc.

Coupons and Discounts Database 121—which can include active coupons, promotional codes, discounts, etc.

Market pricing and analytics database 122—which can include market pricing, product locations, travel options and statistics, competitive intelligence data, etc.

eCommerce Threat Intelligence Database 123—which can include suspicious behavior, malicious users, risky websites, user activity data, user details, communications, location, IP addresses, domains, user risk ratings, known eCommerce threats, new users, newly registered websites, etc.

3rd party system database 135—which can data retrieved from 3rd party systems such as user data, listing data, offer data, etc.

3rd party threat intelligence database 136—security data retrieved from 3rd party systems which can include suspicious behavior, malicious users, risky websites, user activity data, user details, communications, location, IP addresses, domains, user risk ratings, known eCommerce threats, new users, newly registered websites, etc.

The platform includes an overarching system and algorithm for multiway automated active continuous search, multi-search, and active synchronization 101. This algorithm can be an end-to-end active continuous search of listings, records, and/or buyers and is described in more detail below. An automated intelligent multi-level secure eCommerce gateway 102 can be used to provide real-time threat and fraud protection, eCommerce filter, and/or whitelist/blacklist of geography, users, categories, listing attributes or other specified criteria.

Implementations of the system and method can include algorithms for:

Automated Intelligent cloning and Search Text Detection 103 for automated intelligent search along and/or search text detection and sub-search criteria creation.

Automated Negotiation 104 for automated multiway negotiation of pricing and non-pricing criteria.

Predictive Automated Intelligent Purchase 105 for automated discounts/coupons and automated purchasing based on preset criteria.

Multiway Automated Predictive Pricing and Non-Pricing Recommendations and Matching 106a for automated future price search and future non-pricing attributes recommendation, plus seller automated price match.

Multiway Automated Pre-purchase and post-purchase price matching and refunding 106b for automated price match and refunding.

Automated Multiway Match and Save of Unique Results and Offers 107a for automated assurance of unique listing results, offers, buyers, etc.

Automated analysis and activation of unique listings 107b for automated assurance of unique listings

Automated Proactive Seller Offers 108 for automated seller proactive offers using pre-approved seller listing criteria and offer attributes.

One implementation includes an automated active continuous search and match of listings, system generated results, and buyer/API active search criteria. This is achieved via continuous active intelligent search initiated by an automation algorithm enabling buyers/API to preset active search criteria such as pricing criteria, non-pricing criteria, and search timeframe as well as enabling sellers/API to search for buyers/buyer criteria including pricing criteria, non-pricing criteria, and search timeframe and automating multi-level and multiway sub-systems enabling end-to-end automation from the search and all the way through to purchase. The search algorithm also enables automation of sub-search criteria matching and alignment via intelligent input text detection as well as automation of enforcing unique search results and offers via multiway automated matching algorithm that analyzes new, active and deleted/archived results, offers, listings, criteria, pricing attributes, and non-pricing attributes. The system further enhances unique results using the automated analysis and activation algorithm for unique seller/API listings that conducts a cross functional and cross platform analysis and consolidates duplicate listings.

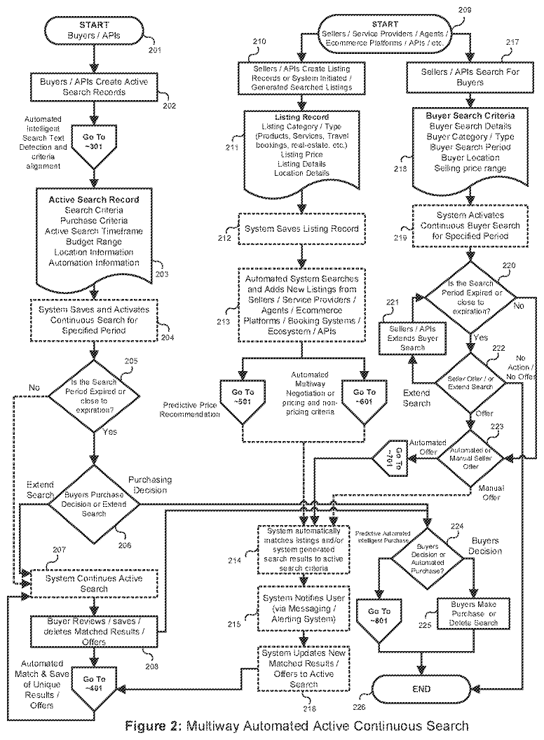

Multiway Automated Active Continuous Search—Buyer (FIG. 2)

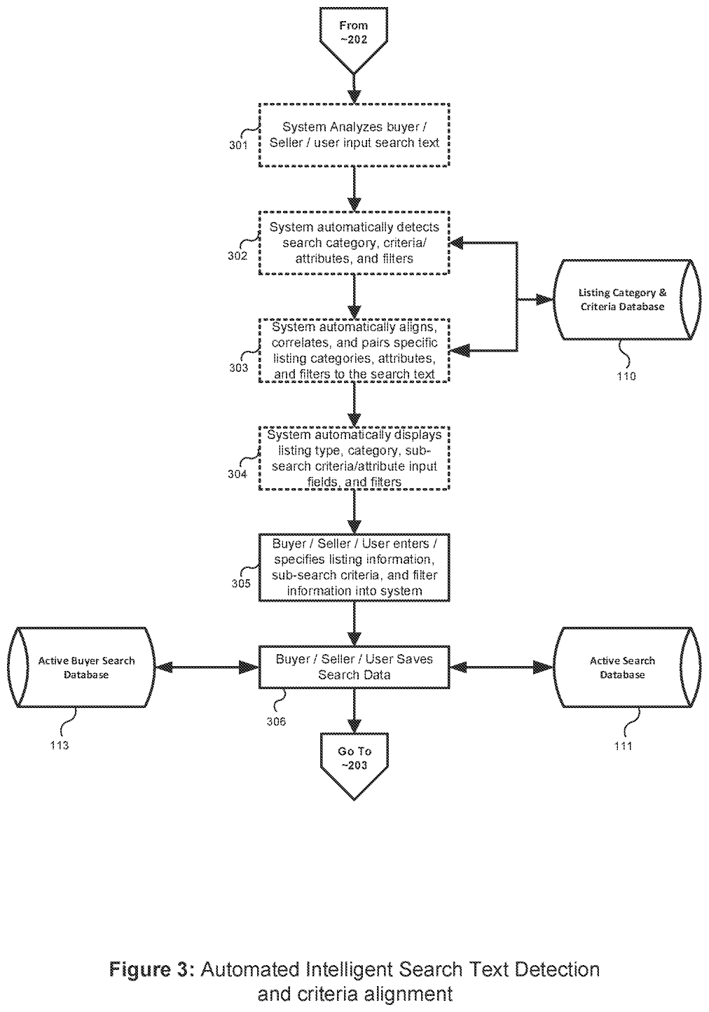

FIG. 2 shows details of multiway automated active continuous search algorithm 101 and is divided into the buyers 201 side and sellers 210 side. For a buyer, step 202 involves the creation of active search records. In step 202, the records can be created or otherwise imported from existing data. For buyer active search, the system provides an enhanced automated active search record creation system utilizing an automated intelligent search text detection to search criteria alignment as explained below with reference to FIG. 3.

Using the active search records created by the buyer from step 202 and/or the active search records from the automated intelligent search text detection and criteria alignment, active search records are compiled in step 203 to include search criteria, purchase criteria, active search timeframe, budget range, location information, and non-pricing flexibility information The system then saves and activates a continuous search for a specified period of time in step 204.

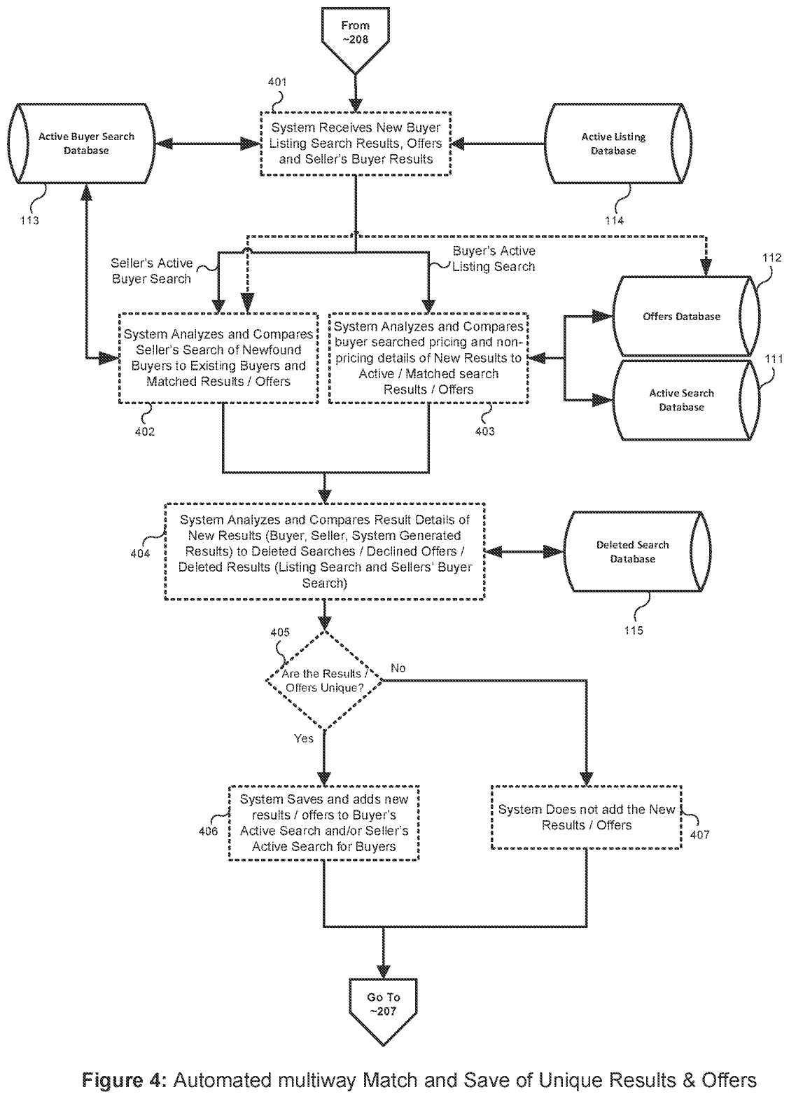

As set forth in step 205, the system continues the active search until the search period expires or is within a specified time of expiring. At which point (step 206), the buyer and/or system makes a purchasing decision or can extend the search as shown in step 207. In making a purchasing decision or extending the search, the buyer can review and save any matched results or offers, deleting any results or offers that are not acceptable or otherwise not of interest to the buyer (step 208). The review process includes the automated match and save of unique results or offers as described below with reference to FIG. 4.

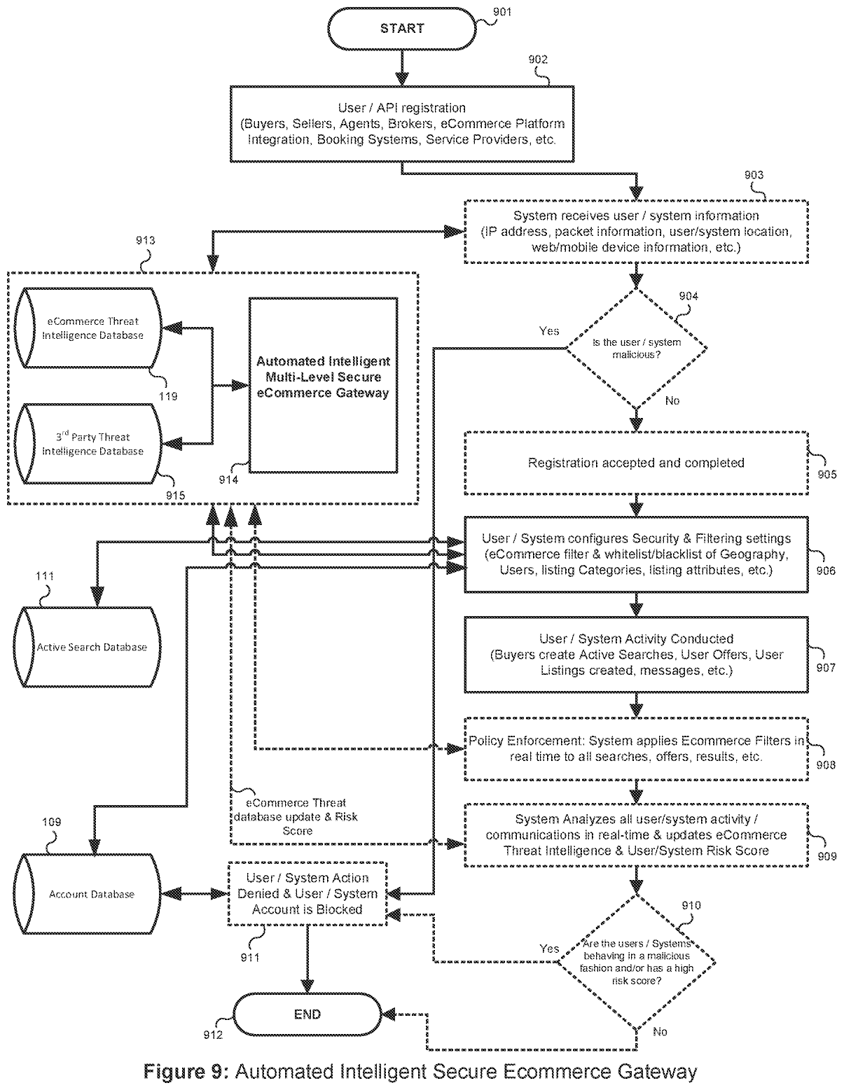

With respect to making a purchasing decision, the buyer can make the decision manually (step 225) or the decision can be an automated purchase as shown in step 224 to end the process (step 226). The automated purchase process is described below in more detail with reference to FIG. 9.

Multiway Automated Active Continuous Search—Seller (FIG. 2)

With respect to sellers, service providers, agents, eCommerce platforms (such as Booking.com), APIs, etc. (referred to generically as sellers 210), there are two possible pathways. In the first, sellers 210 create listing records or the system initiates or generates search listings as shown in step 211. As shown in step 212, the listing records can include the listing details, listing category or type (products, services, travel bookings, real-estate, etc., the listing price, location details, as well as other listing information. The system also activates a continuous search and adds automated system generated listings based on buyer active search records as shown in step 213.

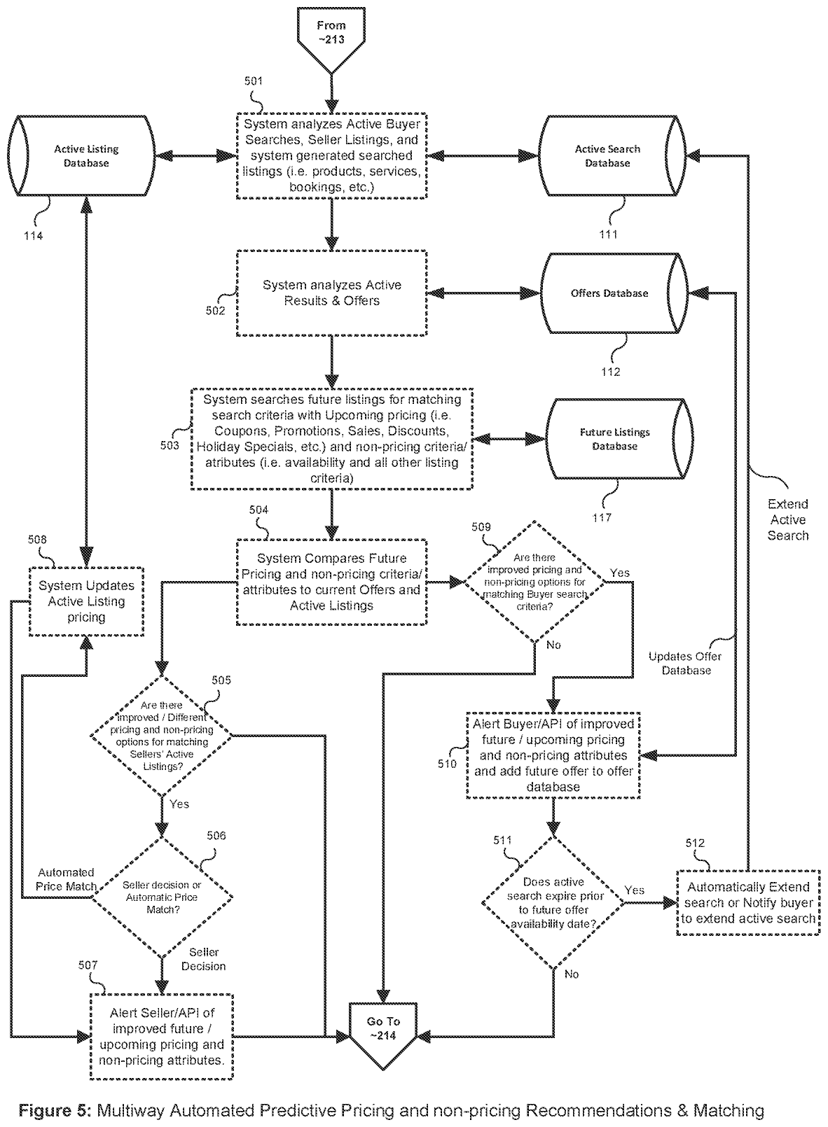

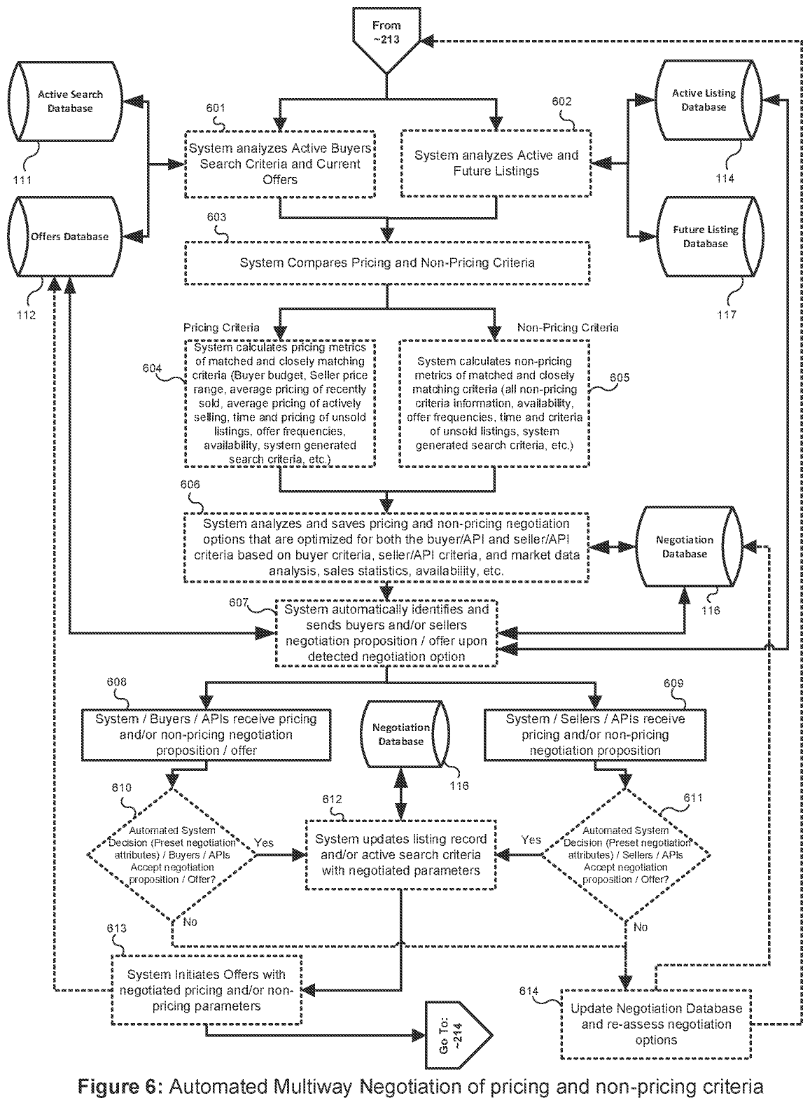

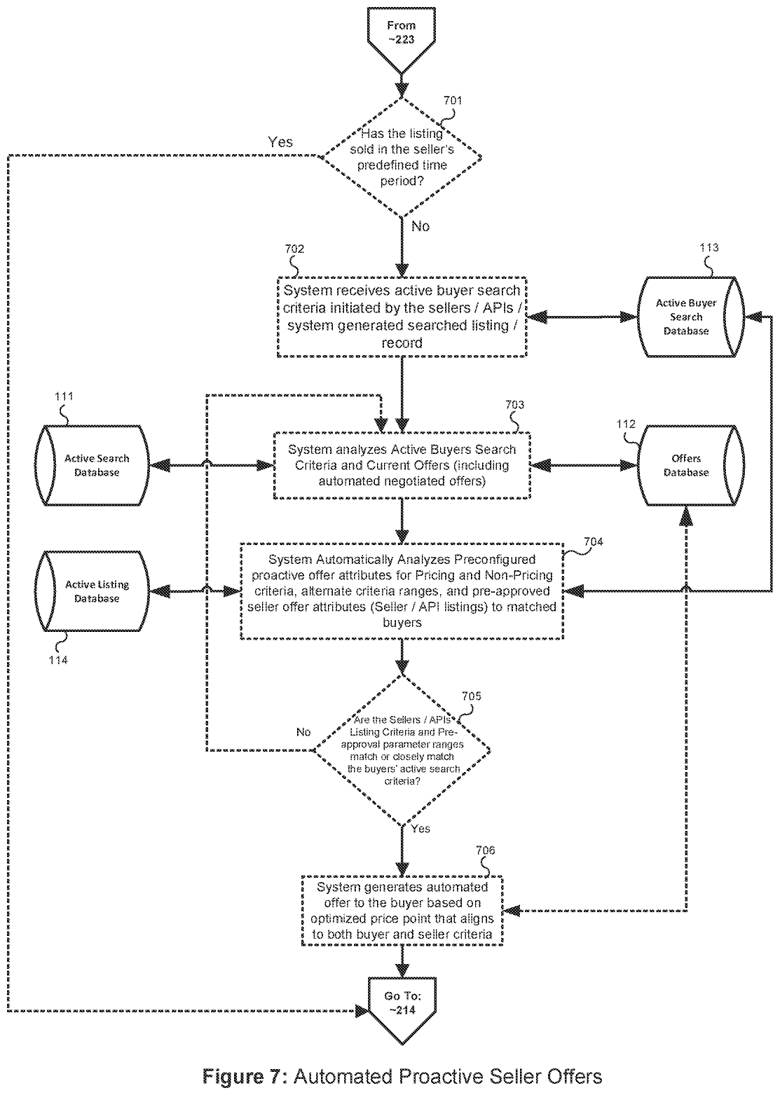

The system then conducts an automated analysis and activation of unique listings described in more detail below with reference to FIG. 5. The system saves the listing record(s) in step 214. Simultaneously the system continuously provides Predictive pricing and non-pricing recommendations (discussed in more detail below with reference to FIG. 6) as well as conducts automated multiway negotiations of pricing and non-pricing criteria within the eCommerce ecosystem described in more detail below with reference to FIG. 7. After which the system automatically matches listings and/or system generated search results to active search criteria (step 215). The system notifies the user of any matches (step 216) and updates new matched results or offers to active searches (step 217).

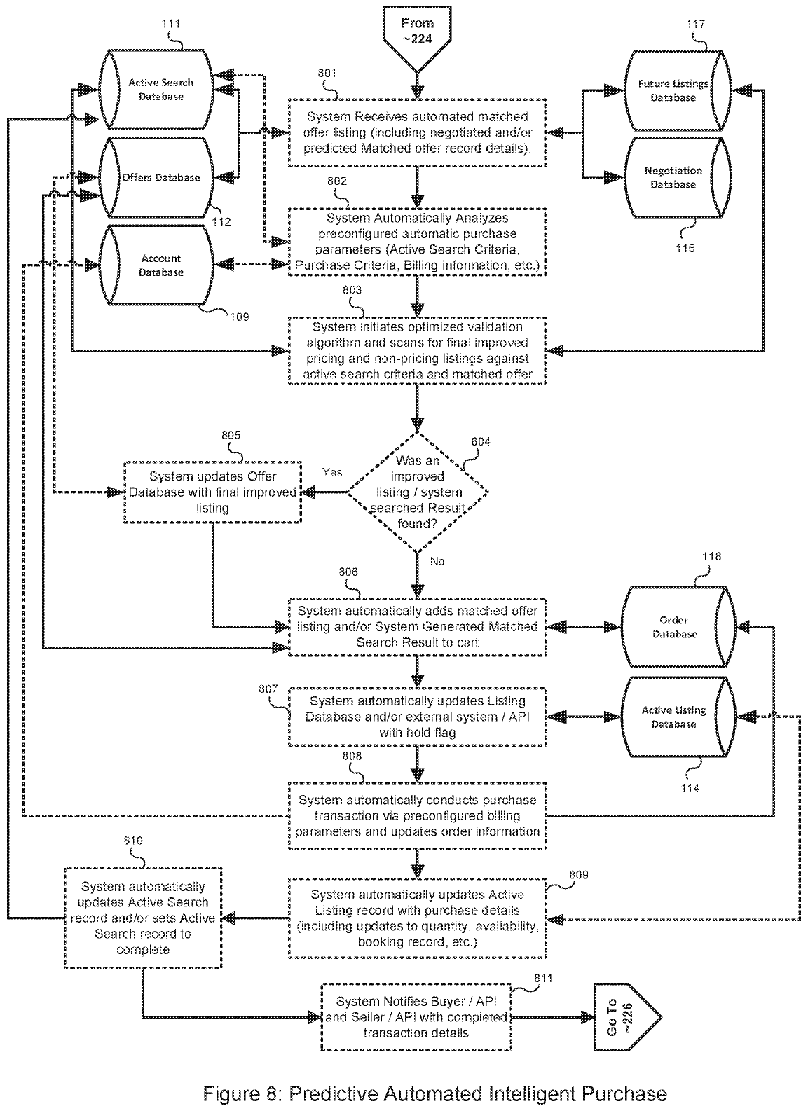

In the second pathway, sellers 210 search for buyers in step 218. For seller active search for buyers, the system provides an enhanced automated active search record creation system utilizing an automated intelligent search text detection to search criteria alignment as explained below with reference to FIG. 3. As shown in step 219, the search criteria can include buyer search details, buyer category or type, buyer search period, buyer location, and selling price range. The system then activates a continuous buyer search for a specified period (step 220). As set forth in step 221, the system continues the active search until the search period expires or is within a specified time of expiring. At which point (step 223), the seller makes an offer decision or can extend the search as shown in step 222. In making an offer decision, if the search expires and no action is made, the process ends (step 227) or an automated offer or manual seller offer (step 224) can be initiated. The automated offer is described in more detail below with reference to FIG. 8. Regardless of whether the offer is manually made or automated, the system automatically matches listings, offers and/or system generated search results to active search criteria (step 215). The system notifies the user of any matches (step 216) and updates new matched results or offers to active searches (step 217).

In another implementation, the system also automatically negotiates pricing and non-pricing of buyer criteria and seller/API/listing attributes in a multiway fashion via negotiation algorithm amongst the eCommerce ecosystem of buyers, sellers, agents, API systems, eCommerce platforms, booking systems, etc. In another implementation, the system also automatically predicts and recommends pricing and non-pricing buyer criteria as well as seller/API/listing attributes in a multiway fashion via predictive algorithm that analyzes current/active criteria/attributes as well as future criteria/attributes amongst the eCommerce ecosystem of buyers, sellers, agents, API systems, eCommerce platforms, booking systems, etc. to optimize/improve the sale outcome. The predictive recommendation algorithm also automatically price matches seller listings based on seller listing attributes, current listings, and future listing attributes.

In another implementation, the system automatically generates proactive seller offers based on seller's sales cycle predefined time period, alternative predefined and preapproved seller matched or closely matched criteria/attributes/parameters, buyer/API active search criteria, system generated search results, and existing offers. In another implementation, the system automatically applies additional available discounts/coupons and automatically conducts buyer purchases utilizing billing information and other criteria relevant to the purchasing process. In another implementation, the system automatically analyzes eCommerce threats, risks, and malicious eCommerce behavior of users and third-party systems in real-time to ensure a safe and secure eCommerce experience.

The system can also provide eCommerce filters, whitelisting, and blacklisting geography, users, listing categories, listing attributes, etc. In this manner the entire eCommerce sales cycle is completely automated for buyers, sellers, and any integrated systems in a relevant, secure, and controlled fashion. Buyers, sellers, service providers, agents, etc. simply create their active search records and/or listings and the multi-level automated, intelligent, predictive, and active eCommerce system conducts the rest of the eCommerce sales process for them across any eCommerce category including products, services, travel, automotive, real estate, etc. with minimal buyer and seller time and effort. The system aims to complete the entire sales cycle with no user interaction nor requirement for sellers and buyers alike to be online.

Automated Intelligent Search Text Detection to Search Criteria Alignment (FIG. 3)

In step 302, the system analyzes buyer and/or seller and/or user input search text. Using the data from listing category and criteria database 110, the system automatically detects the multi-level search criteria, attributes, categories, filters, etc. (step 303) and automatically aligns, correlates, and pairs specific listing attributes, categories, and filters to the search text (step 304). Any new information from steps 303 and 304 based on the inputted search text from step 302 can be added to listing category and criteria database 110.

The system automatically displays the determined listing type, category, sub-search criteria or attribute input fields, filters, etc. (step 305). The buyer and/or seller and/or user can enter or specify active search information, multi-level search criteria, filter information, etc. into the system (step 306). The buyer or seller to save the search data and activate the search (step 307) to the appropriate active buyer search database 113 and/or active search database 111. Alternatively or additionally, the buyer or seller can use previous data from active buyer search database 113 and/or active search database 111.

In this regard, the buyer or seller can choose a previous/historical search record (step 308). Utilizing offers database 112 and/or deleted and historical search and results database 117, the system analyzes historical offers and search results and automatically blocks/rejects activation of duplicate results within the new search (step 310). In step 311, the system clones historical search and creates a new search record. The process continues with step 307 as previously described.

Automated Multiway Match and Save of Unique Results and Offers (FIG. 4)

In step 401, the system receives new buyer listing search results, offers, and seller's buyer search result (see FIG. 2). These results can also come from active listing database 114 and/or active buyer search database 113 and/or offers database 112. The system analyzes and compares seller search of newfound buyers and matched results or offers in step 402. The system also analyzes and compares buyer searched pricing and non-pricing details of new results from step 401 to active/matched search results or offers (step 403). The active/matched search results are from offers database 112 and/or active search database 111.

In step 404, the system can analyze and compare result details of new results (buyer, seller, and/or system generated results) to deleted searches, declined offers, and/or deleted results from deleted search database 117.

The system then takes the results and/or offers from the prior steps and makes a determination whether the results or offers are unique, i.e. not in an existing database. If the results or offers are unique, the system saves and adds the new results and/or offers to the buyer's active search and/or seller's active search for buyers (step 406). If the results are not unique, the system does not add the results and/or offers (step 407).

Automated Analysis and Activation of Unique Listings (FIG. 5)

Step 501 shows the initiation of an automated analysis and activation of unique listings. Specifically, from Non-Active Listings Database 115, 3rd Party System Database 135 of external listings, and Future Listing Database 119, the system receives new, active and future listings via an online eCommerce system synchronization search and active synchronization of Seller listings, API listing records, booking systems, system initiated/generated searched listings, etc. In Step 502, the system automatically analyzes listings for duplicates using advanced detection algorithms by analyzing listing details, seller information, pricing details, usernames, user emails, phone numbers, geographic location, website details, enhanced digital image detection and identification algorithms, optical character recognition algorithms, etc. In Step 503, the system matches the listings to generate a duplicate probability score. If there are no duplicate listings based on this score (Step 504), the system adds the unique listing to the active listings database 114 in Step 505. If there are duplicate listings, the system utilizes optimal listing algorithm(s) to select the optimal listing instance in Step 506. The algorithm(s) can utilize reputation data such as listing URL, listing rating, user/seller rating, source reputation, pricing and non-pricing attributes, listing anomalies, etc. to generate an optimal listing score. The system saves the optimal listing in active listings database 114 and archives expired duplicate listings in expired and historical listings database 116. The process continues with Step 214.

Multiway Automated Predictive Pricing and Non-Pricing Recommendations and Matching (FIG. 6)

In order to provide automated predictive pricing and non-pricing recommendations and matching, the system analyzes active buyer searches from active search database 114, seller and/or system generated listings from active listing database 114 (step 601). The system can also analyze active results and offers from offers database 112 (step 602). In step 603, the system searches future listings in future listings database 119 for matching search criteria with upcoming pricings (e.g. coupons, promotions, sales, discounts, holiday specials, etc.) and non-pricing criteria and attributes (e.g. availability, and all other listing criteria).

In step 604, the system compares future pricing and non-pricing criteria and attributes to current offers and active listings. The system then determines if there are improved or different pricing and non-pricing options for matching seller's active listings (step 605). If the determination is negative, the search process continues with step 215. If the determination is positive (step 606), the seller can make a decision to match after being alerted of these improved future or upcoming pricing and non-pricing attributes (step 607) before the search process continues with step 215. If the seller has implemented an automated price match, the system updates active listing pricing and/or offer in step 608 and the seller is alerted as before in step 607 before the search process continues with step 215.

With respect to step 604 for buyers, the system determines if there are improved or different pricing and non-pricing options for matching buyer search criteria (step 609). If the determination is negative, the search process continues with step 215. If the determination is positive (step 609), the buyer is alerted of these improved future or upcoming pricing and non-pricing attributes (step 610). If the active search does not expire prior to future offer availability date (step 611), the search process continues with step 215. If the active search expires prior to future offer availability date (step 611), the buyer can be notified to extend the active search if so desired or the system can automatically extend the search if the buyer has implemented this feature (step 612).

Automated Multiway Negotiation of Pricing and Non-Pricing Criteria (FIG. 7)

The automated multiway negotiation analyzes data from active listing database 114 and future listing database 119 (step 702). The system also analyzes data from the active search database 111 and offers database 112 (step 701). Using the data from steps 701 and 702, the system compares pricing and non-pricing criteria in steps 703 and 704.

With respect to pricing criteria, in step 703 the system calculates pricing metrics of matched and closely matching criteria (Buyer budget, Seller price range, average pricing of recently sold, average pricing of actively selling, time and pricing of unsold listings, offer frequencies, availability, system generated search criteria, etc.). With respect to non-pricing criteria, in step 704 the system calculates non-pricing metrics of matched and closely matching criteria (all non-pricing criteria information, availability, offer frequencies, time and criteria of unsold listings, system generated search criteria, etc.).

Using the data from steps 703 and 704, the system analyzes and correlates pricing and non-pricing criteria between active searches, offers/results, and listings (step 705). In step 706, the system analyzes, identifies, and saves (in negotiation database 118) pricing and non-pricing negotiation options that are optimized for both the buyer/API and seller/API criteria based on buyer/API criteria, seller/API criteria, sales statistics, availability, etc. as well as market data analysis utilizing data from the market pricing and analytics database 122. In step 707, the system automatically identifies and sends buyers and/or sellers negotiation proposition/offer upon detected negotiation option.

Separately for both buyers (step 708) and sellers (step 709), the system receives the pricing and/or non-pricing negotiation proposition. Then, the system automatically determines whether to accept the negotiation proposition or offer based on preset negotiation attributes (step 710 for buyers and step 711 for sellers). If accepting, the system updates listing record and/or active search criteria with the negotiated parameters (step 712). The system then initiates offers with negotiated pricing and/or non-pricing parameters (step 713). If not accepting, the system updates negotiation database 118 and re-assesses the negotiation options (step 714).

Automated Proactive Seller Offers (FIG. 8)

In step 801, if the listing has not sold in the seller's predefined time period, the system extracts active buyer search criteria in step 802. The criteria can come from active buyer search database 113. Utilizing active listing database 114, the system analyzes active buyer search criteria and current offers (including automated negotiated offers) in step 803. Next in step 804, the system automatically analyzes preconfigured proactive offer attributes for pricing and non-pricing criteria, alternate criteria ranges, and pre-approved seller offer attributes and compares to matching buyers and/or buyer search criteria. Step 805 is analogous to step 804 for buyers.

In step 806, the system determines whether the sellers listing criteria and pre-approved parameters ranges match the buyer's active search criteria with reference to active search for buyers database 113 and offers database 112. If no matched criteria is found, the system can also include closely matching criteria. For example. if an iPhone with the same memory, price, model, and condition is matched, but the color was not (e.g. silver instead of black), the system would make a closely matching recommendation.

If there is a positive determination, the system generates an automated offer to the buyer based on the optimized price point that aligns to both buyer and seller criteria (step 807) and continues the automated search with step 215. If there is a negative determination, the system repeats the process starting with step 804.

Predictive Automated Intelligent Purchase (FIG. 9)

Using data from active search database 111 and offers database 112, the system receives automated matched offer listing (including negotiated and/or predicted matched offer record details) in step 901. Using data from active search database 111 and account database 109, the system automatically analyzes preconfigured automatic purchase parameters (active search criteria, billing information, etc.) in step 902. With reference to coupons and discounts database 121, the system then initiates optimized sales validation algorithm which checks for coupons, promotional codes, discounts, etc. and automatically applied discounted pricing when available (step 903).

If there is a discount found (step 904), the system automatically applies the discounted pricing and updates the offer database 112 with the final discounted/improved pricing (step 905). The system then automatically adds the matched and/or system generated matched results to the cart (step 906) and updates the order database 120. If no discounts are found, the system then automatically adds the original matched offer listing and/or system generated matched search results to the cart (step 906) and updated the order database 120. The system then automatically updates listing database 114 and/or external system with a hold flag (step 907) in order to ensure the listing is locked from other potential buyers during the checkout process. In step 908, the purchase transaction is automatically conducted by the system using preconfigured billing parameters, shipping details, etc. The system also updates the order information. After the purchase transaction, the system automatically updates active listing database 114 with purchase details, including updates to quantity, availability, booking record, etc. (step 909). The system also automatically updates active search record and/or sets active search record to complete in step 910 and notifies the buyer and seller with the completed transaction details in step 911.

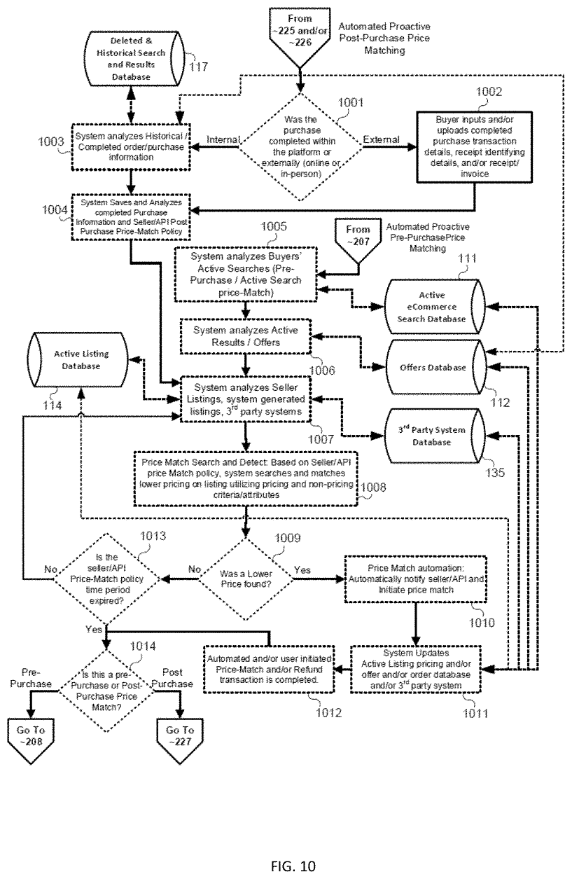

Multiway Automated Pre-Purchase and Post-Purchase Price Matching & Automated Refunding Algorithm (FIG. 10)

For completed purchases (continuing from either Step 225 or Step 226), the system determines whether the purchase was completed within the platform or externally (either online or in person) in Step 1001. If external, the buyer inputs and/or uploads completed purchase transaction details, a receipt identifying the details, and/or the actual receipt or invoice (Step 1002). If internal, the system analyzes historical/completed order/purchase information (Step 1003). In Step 1004, the system saves and analyzes completed purchase information and seller/API post purchase price-match policy as detailed below.

For pre-purchases (continuing from Step 207), the system analyzes the Buyer's active searches in active search database 111 (Step 1005). In Step 1006, the system analyzes the active search results/offers from Offers database 112.

For both post purchases and pre-purchases, the system analyzes seller listings in active listings database 114, system generated listings and 3rd party listings in 3rd party system database 135 (Step 1007). Based on Seller/API price match policy, the system searches and matches lower pricing on listing utilizing pricing and non-pricing criteria/attributes (Step 1008).

If a lower price is not found and the price match policy time period has not expired, the price match search and detection is continued until the time period has expired. Once the time period has expired, the process continues with Step 208 for pre-purchases and with Step 227 for post-purchases.

If a lower price is found, the seller/API is notified and the price match is initiated (Step 1010). The system updates active listing pricing and/or offer database 112, and/or order database and/or 3rd party system database 135 (Step 1011). the process continues with Step 208 for pre-purchases and with Step 227 for post-purchases.

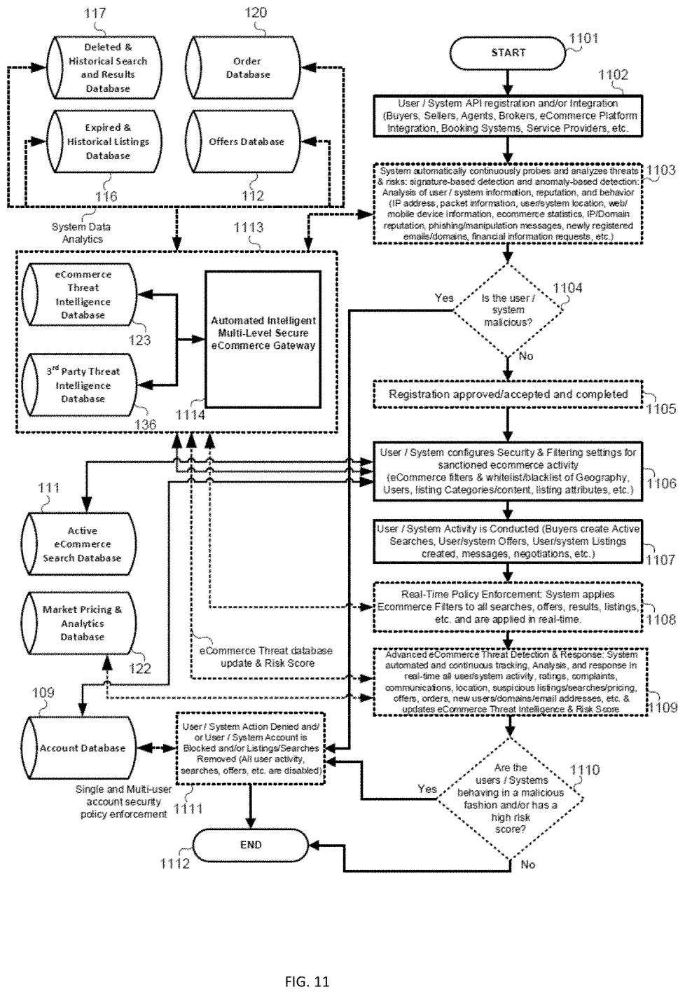

Automated Intelligent Secure eCommerce Gateway (FIG. 11)

Users and/or System API register and/or integrate with the platform as set forth in steps 1101, 1102, and 1103. In addition to the registration information received, the system automatically continuously extracts user and system information (IP address, packet information, user/system location, web/mobile device information, etc.), the system analyzes the eCommerce threat intelligence database 123 and third-party threat intelligence database 136 to make a determination with the automated intelligent multi-level secure eCommerce gateway 1114 as to whether the user/system is malicious (step 1104).

If the determination is positive, action by the user or system is denied and the user or system account is blocked (step 1111), thereby ending the process (step 1112). The denial and blocking can be saved in the account database 109.

If the determination is negative, the registration is accepted and completed (step 1105). The user or system configures security and filter settings such as eCommerce filters, whitelist/blacklist of geography, users, listing categories, listing attributes, etc. (step 1106). The configuration can be saved and applied in active search database 111 and/or account database 109. In step 1107, the user and/or system activity is conducted (buyer searches, seller listings, user communications, etc.)

The system also applies eCommerce filters in real time to all searches, offers, results, etc. (step 1108). The system automatically tracks and analyzes continuously all user activity, ratings, complaints, communications, location, suspicious listings/searches, etc. in real-time and updates eCommerce threat intelligence database 123 as well as the user risk score (step 1109). In step 1110, the system determines if the user is behaving in a malicious fashion and/or has a high-risk score. For example, the system rates each component with a sub risk score then aggregates a total risk score to determine if the user has malicious intent. This can be phishing for user payment details, sending users to 3rd party URLs, sharing personal identifiable information, etc.

If this determination is negative, the process ends in step 1112. If this determination is positive, further action by the user or user system is denied and the user or system account is blocked (step 1111), thereby ending the process (step 1112). The denial and blocking can be saved in the account database 109.

### CONCLUSION

The present disclosure enables a complete end-to-end eCommerce method and system of an automated platform and creates an active system that works on behalf of all integrated entities inclusive of buyers, sellers, service providers, merchants, agents, eCommerce platforms, booking systems, retailers, API based systems, etc. The present disclosure enables buyers to simply activate an online search and the system will do the rest, including continuously searching for the listing, automatically negotiate pricing and non-pricing attributes across the eCommerce spectrum, analyze current and upcoming/future sales listings, automatically recommends listings based on pricing and non-pricing attributes, search for last minute deals, automated price matching, and complete the sales transaction without any buyer action required and based on predefined and pre-approved criteria. The present disclosure also provides sellers the same automated experience where sellers simply list their products or services for example, and the system does the rest including seller negotiations, actively searching for buyers, automating proactive offers, automatically price matches, and completes the sales transaction based on predefined and pre-approved criteria. Furthermore, the present disclosure analyzes malicious behaviors, conducts user risk analysis, and enables eCommerce content filtering capabilities at an account and search level in real time. Current eCommerce platforms are lacking intelligent automation and require buyers and seller action throughout the search and sales cycle. Current platforms also lack predictive automated future looking mechanisms and automated pricing and non-pricing analysis to deliver an optimal buyer and seller outcome. Moreover, current platforms lack real-time security and content filtering capabilities. The present disclosure optimizes and solves all aspects of the end-to-end eCommerce sales cycle and automates the entire sales cycle through an active, intelligent, automated, secure, relevant, controlled, and predictive system and method.

As should be evident from the above description, the disclosure relates to a method and system for a multi-level active, automated, intelligent, secure, relevant, and predictive eCommerce platform. The system automates the end-to-end eCommerce process via automated and intelligent algorithms, including active continuous search of buyer criteria as well as seller search for buyers. The system automates the searching and matching of buyer/API active search criteria to the seller ecosystem including individual sellers, retailers, corporate sellers, service providers, travel/booking systems, eCommerce systems, APIs, etc. in a multiway fashion, including active listings and system generated search results.

Current eCommerce solutions generally are inefficient as they lack a time vector, lack of scale across a multitude of platforms and industries, lack of capturing price fluctuation impacts, and lack of closely matched pricing and non-pricing criteria to enhance the buying experience. Further, current platforms require users to continually search to find and capture listings, search-based results, and price points over time. The disclosed system and method minimize time and effort by automating and capturing pricing and non-pricing attributes over time for the users.

Furthermore, current platforms require sellers to advertise across multiple platforms/systems and are dependent on the systems and buyers to engage them and are on a holding period until that happens. The disclosed system and method also automate a continuous active search for sellers to proactively search for relevant buyers across multiple systems utilizing a predefined time period and proactively provides new buyer leads and generate automated seller offers in real-time as a buyer active search criteria is matched and/or closely matched. The disclosed system and method also automate real-time eCommerce filtering and security using eCommerce filters such as geography, users, listing categories, listing attributes, etc. as well as real-time eCommerce threat detection and analysis.

The disclosed system and method automate negotiation of pricing and non-pricing attributes in multiway fashion. The system automates negotiation utilizing data analysis of buyer budget, seller price range, market sold and unsold information, offer frequencies, availability, upcoming/future listings, etc. to auto-negotiate across a multiway buyer and seller ecosystem that is enhanced to optimize the outcome for both the buyers/API and sellers/API alike.

Current platforms also lack intelligence of matching and/or closely matching search criteria of pricing and non-pricing attributes. The disclosed system and method automate and add criteria and market data analysis to intelligently negotiate automatically on behalf of all parties involved. Current eCommerce systems do not automate the negotiation process which is very time consuming and inefficient for users and businesses. Furthermore, users that lack negotiation experience and are uncomfortable with interacting with other users online are forced to either walk away from a transaction or will lead to a non-optimal transaction for all parties involved.

The disclosed system and method automatically conduct multiway predictive recommendations of future listings and/or future system generated results via predictive algorithm that analyzes upcoming and future listings/results of pricing and non-pricing attributes that match and/or closely match buyer active search criteria. Additionally, the disclosed system and method automatically conduct price matching for active listings based on active and upcoming/future listings and/or system generated results. In current eCommerce platforms, users have no pricing and non-pricing insight into future listings which impact the ability to make intelligent purchasing and selling decisions. There is currently no automated method or system for sellers to automatically price match based on existing and/or upcoming listing information.

The disclosed system and method also automate proactive seller offers. The system utilizes the seller search for buyers and adds automated proactive seller offers based on matched and/or closely matched pre-configured pricing and non-pricing criteria/criteria ranges and pre-approved seller offer attributes. The algorithm enables a proactive offer mechanism on listings that require the expedition of the sales process utilizing a preset time-period, sales listing frequency, alternative criteria range, and an automated proactive approach to enable the sale. Existing eCommerce platforms do not provide automated proactive seller offers and not across multiple systems which is very time consuming for sellers and reduces seller control of sales outcomes.

The disclosed system and method enable intelligent automated purchases with a predictive ‘last minute’ deal validation prior to payment. The system utilizes preconfigured automatic purchase parameters such as active search criteria, automated purchase criteria, billing information, order information, etc. to automatically complete a transaction. Prior to completing the transaction, the system also conducts an additional last-minute scan for improved pricing and non-pricing matching criteria to ensure optimal transaction is completed.

The eCommerce ecosystem is very dynamic and new listings and deals are constantly changing, the disclosed system and method provide an additional layer of pricing and non-pricing validation prior to purchase. Furthermore, the present system enables an additional automation layer to enable to true automated end-to-end experience through to transaction completion. Current eCommerce platforms do not support an automated purchasing system.

The disclosed system and method conduct an automated intelligent search text detection and criteria alignment. The system simplifies the user experience through text detection to automate the experience by aligning and pairing search categories, sub-search criteria, and search filters to the user input. The system eliminates the need to pre-select categories and criteria and reduces time and effort for searches conducted by users (buyers and sellers alike). Current eCommerce systems require manual selection of categories and criteria which are cumbersome and require times and effort by the users.

The disclosed system and method conduct automated multiway match and save of unique results and offers. The system analyzes and compares buyer's active search pricing and non-pricing details of new results to active/matched search results and offers. Furthermore, the system analyzes seller's search of newfound buyers to existing buyers and matched results and offers. The system conducts a unique results validation against existing, declined, deleted, or archived results, offers, buyers, etc. to ensure that no duplicate results or offers will be matched on the current search as long as the search is active to enhance the user experience. The disclosed system and method ensure that same results and offers will not impact the quality of the search for users (buyers and sellers alike). Current eCommerce platforms do not have a mechanism to mitigate duplicate results and offers once a specific results or offer has been declined, deleted, or archived.

The disclosed system and method conduct automated, intelligent, real-time detection and analysis of eCommerce threats, risks, and malicious eCommerce behavior of users and third-party systems to ensure a safe and secure eCommerce experience. The real-time security system blocks user registration, offers, listings, etc. in real-time to ensure that no fraudulent transactions are conducted. The system utilizes user risk scores, internal threat intelligence databases, as well as third party threat intelligence databases to ensure optimal intelligence around malicious intent. The system also provides eCommerce filters, whitelisting, and blacklisting of geography, users, listing categories, listing attributes, etc. to further reduce risk and ensure a relevant and optimal eCommerce sales experience. Current platforms do not provide real-time eCommerce threat intelligence nor do current platforms provide multi-level eCommerce filtering, whitelisting, and blacklisting capabilities to ensure relevant content on a global, account level, search level, etc. scale.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further implementations of the present disclosure.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

What is claimed is:

1. A system comprising a computer including a processor and a memory, the memory including instructions such that the processor is programmed to:
receive a buyer search query, the buyer search query including pricing details and non-pricing details;
initiate a continuous search for a predefined time period based on the buyer search query; and
execute an automated purchase based on the continuous search.

2. The system of claim 1, wherein the continuous search includes searching records in a future listings database, the future listings database including information corresponding to future pricing details.

3. The system of claim 2, wherein the processor is further programmed to execute the automated purchase after a future offer availability date defined within the future listings database.

4. The system of claim 1, wherein the processor is further programmed to initiate a refund corresponding to the automated purchase based on post purchase price matching.

5. The system of claim 1, wherein the processor is further programmed to determine a negotiation proposition based on at least one of market data analysis, sales statistics, or availability.

6. The system of claim 1, wherein the continuous search includes searching records in a threat intelligence database to mitigate fraudulent offerings.

7. The system of claim 1, wherein the processor is further programmed to compare the buyer search query to listings retained in an active search database.

8. A method comprising:
receiving a buyer search query, the buyer search query including pricing details and non-pricing details;
initiating a continuous search for a predefined time period based on the buyer search query; and
executing an automated purchase based on the continuous search.

9. The method of claim 8, wherein the continuous search includes searching records in a future listings database, the future listings database including information corresponding to future pricing details.

10. The method of claim 9, the method further comprising filtering previously unwanted results upon re-initiating an existing search.

11. The method of claim 8, the method further comprising initiating a refund corresponding to the automated purchase based on post purchase price matching.

12. The method of claim 8, the method further comprising determining a negotiation proposition based on at least one of market data analysis, sales statistics, or availability.

13. The method of claim 8, wherein the continuous search includes searching records in a threat intelligence database to mitigate fraudulent offerings.

14. The method of claim 8, the method further comprising converting input text to a search criteria.

15. A system comprising a computer including a processor and a memory, the memory including instructions such that the processor is programmed to:
create an active search record based on a buyer search query received through an application programming interface, the buyer search query including pricing details and non-pricing details;
initiate a continuous search for a predefined time period based on the buyer search query; and
execute an automated purchase based on the continuous search.

16. The system of claim 15, wherein the continuous search includes searching records in a future listings database, the future listings database including information corresponding to future pricing details.

17. The system of claim 16, wherein the processor is further programmed to execute the automated purchase after a future offer availability date defined within the future listings database.

18. The system of claim 15, wherein the processor is further programmed to initiate a refund corresponding to the automated purchase based on post purchase price matching.

19. The system of claim 15, wherein the processor is further programmed to determine a negotiation proposition based on at least one of market data analysis, sales statistics, or availability.

20. The system of claim 15, wherein the continuous search includes searching records in a threat intelligence database to mitigate fraudulent offerings.
